(19) United States
(12) Patent Application Publication
(10) Pub. No.: US 2026/0269277 A1
(43) Pub. Date: Sep. 10, 2026

(54) METHOD FOR MANUFACTURING ELECTRODE, METHOD FOR MANUFACTURING MEMBRANE ELECTRODE ASSEMBLY, AND METHOD FOR INSPECTING ELECTRODE

(71) Applicant: HONDA MOTOR CO., LTD., TOKYO (JP)

(72) Inventors: Takayuki SAITO, WAKO-SHI (JP); Shinsuke CHOKYU, WAKO-SHI (JP); Yohei KATAOKA, WAKO-SHI (JP); Wataru KASHI, WAKO-SHI (JP); Kento KUSATSUGU, WAKO-SHI (JP)

(21) Appl. No.: 19/554,974

(22) Filed: Mar. 3, 2026

(30) Foreign Application Priority Data
Mar. 5, 2025 (JP) 2025-034203

(51) Int. Cl. H01M 4/88; C25B 11/032; C25B 11/052; C25B 13/02; H01M 4/86

(52) U.S. Cl. CPC H01M 4/8892; C25B 11/032; C25B 11/052; C25B 13/02; H01M 4/8657; H01M 4/8807

(57) ABSTRACT

A method for manufacturing an electrode for a membrane electrode assembly includes a protective layer forming step and an analyzing step. In the protective layer forming step, a protective layer (a first protective layer, a second protective layer) is provided on an electrode catalyst layer (a first electrode catalyst layer, a second electrode catalyst layer) provided on one end surface of a gas diffusion layer (a first gas diffusion layer, a second gas diffusion layer). In the analyzing step, radiation is made incident on the electrode catalyst layer through the protective layer. The amount of radiation incident on the electrode catalyst layer is reduced by the protective layer. In this state, an element in the electrode catalyst layer is analyzed.

### CROSS-REFERENCE TO RELATED APPLICATIONS

This application is based upon and claims the benefit of priority from Japanese Patent Application No. 2025-034203 filed on Mar. 5, 2025, the contents of which are incorporated herein by reference.

### BACKGROUND OF THE INVENTION

### Field of the Invention

The present disclosure relates to a method for manufacturing an electrode, a method for manufacturing a membrane electrode assembly, and a method for inspecting an electrode.

### Description of the Related Art

An electrochemical device such as a fuel cell or a water electrolysis apparatus includes a membrane electrode assembly. The membrane electrode assembly is a structure in which an anode is provided on one end surface of an electrolyte membrane and a cathode is formed on the other end surface of the electrolyte membrane. Each of the anode and the cathode includes a gas diffusion layer and an electrode catalyst layer. The electrode catalyst layer includes an electrode catalyst and a conductive binder.

For the anode and the cathode configured as described above, it is required to inspect whether or not a predetermined amount of metal (platinum or the like) as an electrode catalyst is contained in the electrode catalyst layer, or whether or not impurities are contained in the electrode catalyst layer, for example. Therefore, as described in JP 2018-098096 A, it is conceivable to perform X-ray fluorescence analysis. The inspection target in the technique disclosed in JP 2018-098096 A is an electrode for a secondary battery.

### SUMMARY OF THE INVENTION

In the case where an inspection is performed by irradiating an electrode catalyst layer with fluorescent X-rays according to the disclosure of JP 2018-098096 A, a light element among constituent elements of an ionomer resin contained as a conductive binder in the electrode catalyst layer may be separated.

The present disclosure has the object of solving the above-described problem.

A first aspect of the present disclosure is characterized by a method for manufacturing an electrode for a membrane electrode assembly, the electrode including a gas diffusion layer, and an electrode catalyst layer that is a reaction field of a gas diffused from the gas diffusion layer, the method comprising: forming the electrode catalyst layer containing an electrode catalyst and an ionomer resin on one end surface of the gas diffusion layer; forming a protective layer containing the ionomer resin on the electrode catalyst layer; and irradiating the electrode catalyst layer with radiation through the protective layer and analyzing an element in the electrode catalyst layer, wherein an amount of the radiation incident on the electrode catalyst layer is made smaller by the protective layer than an amount of the radiation incident on the protective layer.

A second aspect of the present disclosure is characterized by a method for manufacturing a membrane electrode assembly that includes: an electrode including a gas diffusion layer, and an electrode catalyst layer that is a reaction field of a gas diffused from the gas diffusion layer; and an electrolyte membrane including one end surface provided with the electrode, the method comprising: forming the electrode catalyst layer containing an electrode catalyst and an ionomer resin on one end surface of the gas diffusion layer; forming a protective layer containing the ionomer resin on the electrode catalyst layer; irradiating the electrode catalyst layer with radiation through the protective layer and analyzing an element in the electrode catalyst layer of the electrode obtained through the forming of the electrode catalyst layer and the forming of the protective layer, the analyzing being performed in a state where an amount of the radiation incident on the electrode catalyst layer is made smaller by the protective layer than an amount of the radiation incident on the protective layer; and joining the electrode that has undergone the analyzing, to the one end surface of the electrolyte membrane.

A third aspect of the present disclosure is characterized by a method for inspecting an electrode for a membrane electrode assembly, the electrode including a gas diffusion layer, and an electrode catalyst layer provided on one end surface of the gas diffusion layer and containing an electrode catalyst and an ionomer resin, the electrode further including a protective layer provided on the electrode catalyst layer and containing the ionomer resin, the method comprising irradiating the electrode catalyst layer with radiation through the protective layer and analyzing an element in the electrode catalyst layer, wherein an amount of the radiation incident on the electrode catalyst layer is made smaller by the protective layer than an amount of the radiation incident on the protective layer.

According to the present disclosure, a situation is suppressed in which a light element among the constituent elements of the ionomer resin contained in the electrode catalyst layer is separated from the ionomer resin due to irradiation with radiation.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic cross-sectional view showing a cross section of a membrane electrode assembly taken along a stacking direction;

FIG. 2 is a schematic diagram of a joined body manufacturing apparatus including an anode manufacturing apparatus constituting an electrode manufacturing apparatus;

FIG. 3 is a schematic diagram of a cathode manufacturing apparatus constituting the electrode manufacturing apparatus;

FIG. 4 is a schematic flow of a method for manufacturing the membrane electrode assembly; and

FIG. 5 is a schematic diagram showing a situation in which an analyzing step is performed using an analysis device.

### DETAILED DESCRIPTION OF THE INVENTION

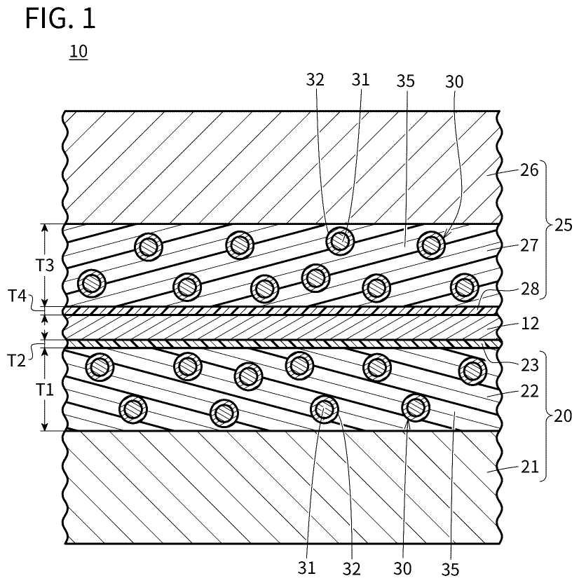

First, a membrane electrode assembly 10 will be described with reference to FIG. 1. As shown in FIG. 1, the membrane electrode assembly 10 includes an electrolyte membrane 12, an anode 20, and a cathode 25. The anode 20 and the cathode 25 are electrodes for the membrane electrode assembly 10.

The anode 20 includes a first gas diffusion layer 21 and a first electrode catalyst layer 22. The cathode 25 includes a second gas diffusion layer 26 and a second electrode catalyst layer 27. The first electrode catalyst layer 22 and the second electrode catalyst layer 27 face each other with the electrolyte membrane 12 interposed therebetween. The membrane electrode assembly 10 constitutes, for example, a single cell of a fuel cell. Alternatively, the membrane electrode assembly 10 constitutes a single cell of an electrochemical decomposition apparatus such as a water electrolysis apparatus.

The first gas diffusion layer 21 is a porous layer in which a gas supplied to the first gas diffusion layer 21 diffuses. Examples of the gas supplied to the first gas diffusion layer 21 include a hydrogen gas. Similarly, the second gas diffusion layer 26 is a layer in which a gas supplied to the second gas diffusion layer 26 diffuses. Examples of the gas supplied to the second gas diffusion layer 26 include an oxygen-containing gas such as compressed air. In the water electrolysis apparatus, the oxygen-containing gas may be supplied to the first gas diffusion layer 21, and the hydrogen gas may be supplied to the second gas diffusion layer 26.

In the case where the membrane electrode assembly 10 is used in a fuel cell, carbon paper is exemplified as the material of each of the first gas diffusion layer 21 and the second gas diffusion layer 26. In the case where the membrane electrode assembly 10 is used in an electrochemical decomposition apparatus, a porous sintered nickel-based alloy is exemplified as the material of each of the first gas diffusion layer 21 and the second gas diffusion layer 26. In the latter case, the material of the first gas diffusion layer 21 may be a porous sintered nickel-based alloy, and the material of the second gas diffusion layer 26 may be carbon paper.

The first electrode catalyst layer 22 includes an electrode catalyst 30 and an ionomer resin 35 as a conductive binder. The electrode catalyst 30 is formed by, for example, supporting catalyst particles 32 on a conductive support 31. Examples of the conductive support 31 include carbon. Examples of the catalyst particles 32 include noble metal particles such as platinum particles or palladium particles. The ionomer resin 35 (the conductive binder) functions as a binder that can hold the catalyst particles 32 and that adheres well to the first gas diffusion layer 21 and the electrolyte membrane 12. The type of the ionomer resin 35 varies depending on the application of the membrane electrode assembly 10. For example, in the case where the membrane electrode assembly 10 is used in a fuel cell, specific examples of the ionomer resin 35 include a perfluorocarbon resin having a sulfonic acid group. In the case where the membrane electrode assembly 10 is used in an electrochemical decomposition apparatus, specific examples of the ionomer resin 35 include a perfluorocarbon resin having a sulfonic acid group and a polymer resin having a quaternary ammonium group.

The gas supplied to the anode 20 passes through the first gas diffusion layer 21, and then reaches the first electrode catalyst layer 22 to participate in an electrode reaction. That is, the first electrode catalyst layer 22 is a reaction field of the gas. The catalyst particles 32 accelerate the electrode reaction.

The second electrode catalyst layer 27 is configured in the same manner as the first electrode catalyst layer 22. The gas supplied to the cathode 25 passes through the second gas diffusion layer 26 and then participates in an electrode reaction in the second electrode catalyst layer 27 serving as a reaction field.

The anode 20 includes a first protective layer 23 (protective layer), and the cathode 25 includes a second protective layer 28 (protective layer). The first protective layer 23 contains the same type of ionomer resin 35 as the ionomer resin 35 contained in the first electrode catalyst layer 22. For example, in the case where the ionomer resin 35 contained in the first electrode catalyst layer 22 is a perfluorocarbon resin having a sulfonic acid group, the ionomer resin 35 contained in the first protective layer 23 is a perfluorocarbon resin having a sulfonic acid group. In the case where the ionomer resin 35 contained in the first electrode catalyst layer 22 is a polymer resin having a quaternary ammonium group, the ionomer resin 35 contained in the first protective layer 23 is a polymer resin having a quaternary ammonium group. Similarly, the second protective layer 28 contains the same type of ionomer resin 35 as the ionomer resin 35 contained in the second electrode catalyst layer 27.

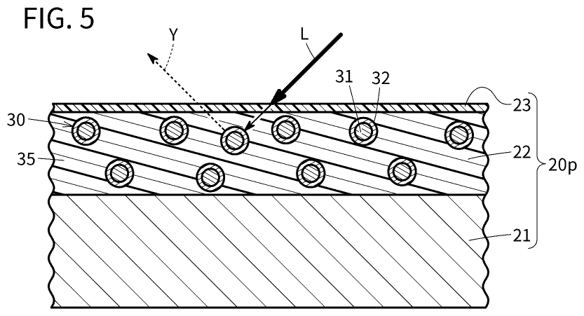

In the case where the first protective layer 23 and the second protective layer 28 containing the ionomer resin 35 as described above are irradiated with radiation L (see FIG. 5) such as X-rays, the first protective layer 23 and the second protective layer 28 absorb part of the radiation L. In other words, the first protective layer 23 and the second protective layer 28 block part of the radiation L. That is, in the case where the radiation L such as X-rays is emitted from the first protective layer 23 side or the second protective layer 28 side, the remaining radiation, which is the radiation L after part thereof has been absorbed, reaches the first electrode catalyst layer 22 or the second electrode catalyst layer 27.

A thickness T2 of the first protective layer 23 shown in FIG. 1 is preferably smaller than a thickness T1 of the first electrode catalyst layer 22. This prevents the radiation L from being entirely blocked by the first protective layer 23. When the thickness T1 of the first electrode catalyst layer 22 is approximately 100 μm, the thickness T2 of the first protective layer 23 is preferably in the range of 2 μm to 20 μm. In this case, the overvoltage in the membrane electrode assembly 10 is prevented from increasing to a non-negligible level, compared to the overvoltage in a membrane electrode assembly that does not include a protective layer.

A gasket (not shown) is mounted on the outer periphery of the membrane electrode assembly 10 configured as described above. That is, the membrane electrode assembly 10 with the gasket mounted thereon is incorporated into a fuel cell or an electrochemical decomposition apparatus.

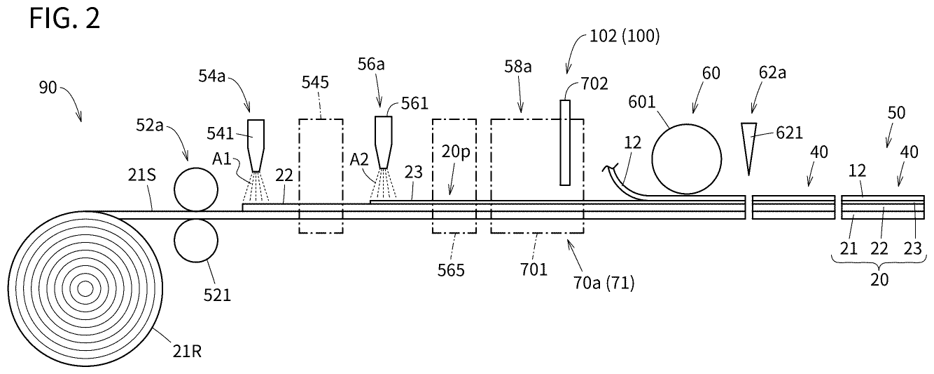

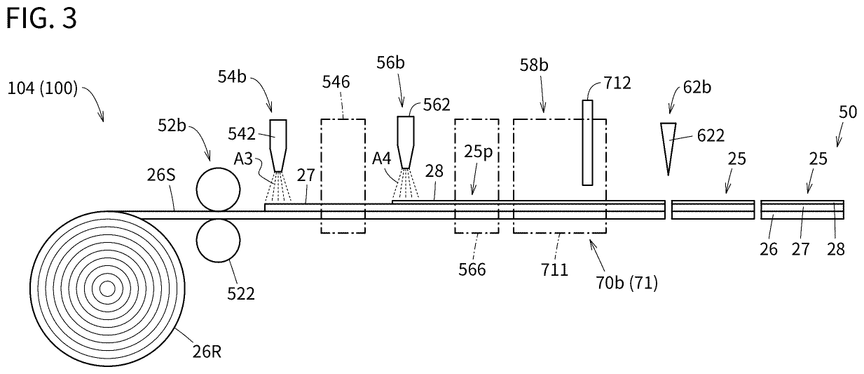

Next, a structure manufacturing apparatus 50 for manufacturing the membrane electrode assembly 10 will be schematically described with reference to FIGS. 2 and 3. The structure manufacturing apparatus 50 includes a joined body manufacturing apparatus 90 shown in FIG. 2, and a cathode manufacturing apparatus 104 shown in FIG. 3.

As shown in FIG. 2, the joined body manufacturing apparatus 90 includes a drawing unit 52a, a first coating unit 54a, a second coating unit 56a, an inspection unit 58a, a joining unit 60, and a trimming unit 62a. The first coating unit 54a, the second coating unit 56a, and the inspection unit 58a also serve as an anode manufacturing apparatus 102 that constitutes an electrode manufacturing apparatus 100. That is, the anode manufacturing apparatus 102 constitutes a part of the structure manufacturing apparatus 50 and a part of the joined body manufacturing apparatus 90. The anode manufacturing apparatus 102 further includes a conveyor (not shown) extending from the drawing unit 52a to the trimming unit 62a.

A roll body 21R of the first gas diffusion layer 21 is held by the drawing unit 52a. The material of the first gas diffusion layer 21 is, for example, a porous sintered nickel-based alloy. Drawing rollers 521 of the drawing unit 52a draw a strip-shaped material 21S from the roll body 21R. The conveyor transports the strip-shaped material 21S.

The first coating unit 54a includes a first coater 541 and a first dryer 545. The second coating unit 56a includes a second coater 561 and a second dryer 565. Each of the first coater 541 and the second coater 561 is, for example, a known coater such as a spray coater, a die coater, or a blade coater. Each of the first dryer 545 and the second dryer 565 is, for example, a heating furnace. Alternatively, each of the first dryer 545 and the second dryer 565 may be a hot air blower.

The inspection unit 58a includes an analysis device 70a that can emit the radiation L. A preferred specific example of the analysis device 70a is an X-ray fluorescence analyzer 71. However, the analysis device 70a may be a device capable of emitting alpha-rays, beta-rays, gamma-rays, or the like. As shown in FIG. 2, the analysis device 70a includes an inspection box 701, and an irradiator 702 that emits the radiation L.

The joining unit 60 includes, for example, a hot press device 601. The trimming unit 62a includes a trimming machine 621.

The cathode manufacturing apparatus 104 shown in FIG. 3 constitutes the electrode manufacturing apparatus 100 together with the anode manufacturing apparatus 102. The cathode manufacturing apparatus 104 is configured in the same manner as the anode manufacturing apparatus 102 except that the cathode manufacturing apparatus 104 does not include the joining unit 60 shown in FIG. 2. Specifically, the cathode manufacturing apparatus 104 includes a drawing unit 52b, a first coating unit 54b, a second coating unit 56b, an inspection unit 58b, and a trimming unit 62b. The cathode manufacturing apparatus 104 further includes a conveyor (not shown) for transporting a strip-shaped material 26S.

A roll body 26R of the second gas diffusion layer 26 is held by the drawing unit 52b. The material of the second gas diffusion layer 26 is, for example, carbon paper. The drawing unit 52b includes drawing rollers 522 for drawing the strip-shaped material 26S from the roll body 26R.

The first coating unit 54b includes a first coater 542 and a first dryer 546. The second coating unit 56b includes a second coater 562 and a second dryer 566. The inspection unit 58b includes an analysis device 70b (for example, an X-ray fluorescence analyzer 71) capable of emitting the radiation L. The trimming unit 62b includes a trimming machine 622.

Next, a method for manufacturing the membrane electrode assembly 10 according to the present embodiment will be described in association with a method for manufacturing an electrode and also in association with a method for inspecting an electrode. Note that the “coating liquid” in the following description includes slurry having a relatively high viscosity. Further, “coating” means supplying the coating liquid to a supply target of the coating liquid. Therefore, “coating” includes “spraying”.

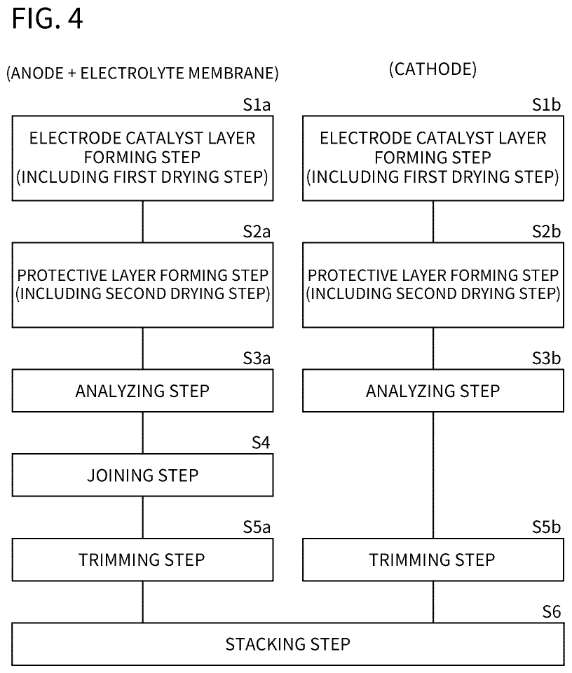

FIG. 4 is a schematic flow of the method for manufacturing the membrane electrode assembly 10. The manufacturing method includes a process of manufacturing a joined body 40 (see FIG. 2) of the anode 20 and the electrolyte membrane 12, and a process of manufacturing the cathode 25. Note that the process of obtaining the anode 20 includes the method for manufacturing the electrode according to the present embodiment. The process of obtaining the cathode 25 also includes the method for manufacturing the electrode according to the present embodiment.

The process of manufacturing the joined body 40 includes an electrode catalyst layer forming step S1a, a protective layer forming step S2a, an analyzing step S3a, and a joining step S4. In the present embodiment, an aspect in which a trimming step S5a is performed after the joining step S4 is shown as an example. It should be noted that, in the analyzing step S3a, the method for inspecting the electrode according to the present embodiment is performed.

In order to manufacture the anode 20, first, as shown in FIG. 2, the strip-shaped material 21S is drawn out from the roll body 21R by the drawing rollers 521. The strip-shaped material 21S is transferred to the first coating unit 54a by the conveyor. In the first coating unit 54a, the electrode catalyst layer forming step S1a is performed. Specifically, a coating liquid A1 to be the first electrode catalyst layer 22 is supplied from the first coater 541 to one end surface of the strip-shaped material 21S. The coating liquid A1 contains the electrode catalyst 30 and the ionomer resin 35 shown in FIG. 1. The coating liquid A1 is dried by being heated by the first dryer 545. That is, a first drying step shown in FIG. 4 is performed. As a result, the first electrode catalyst layer 22 having a substantially uniform thickness T1 is obtained.

The portion of the strip-shaped material 21S (see FIG. 2) where the first electrode catalyst layer 22 is formed is transferred to the second coating unit 56a by the conveyor. In the second coating unit 56a, the protective layer forming step S2a is performed. Specifically, a coating liquid A2 to be the first protective layer 23 is supplied from the second coater 561 onto the first electrode catalyst layer 22 formed on the strip-shaped material 21S. The coating liquid A2 contains the ionomer resin 35 capable of absorbing (blocking) part of the radiation L. The coating liquid A2 is dried by being heated by the second dryer 565. That is, a second drying step shown in FIG. 4 is performed. As a result, the first protective layer 23 having a substantially uniform thickness T2 is obtained.

It should be noted that the thickness T2 of the first protective layer 23 can be made smaller than the thickness T1 of the first electrode catalyst layer 22 by the second coater 561 adjusting the supply amount of the coating liquid A2. It is also possible to obtain the first protective layer 23 having the thickness T2 of 2 μm to 20 μm by the second coater 561 adjusting the supply amount of the coating liquid A2.

In this manner, a strip-shaped first electrode portion 20p is obtained, in which the first electrode catalyst layer 22 and the first protective layer 23 are stacked on the first gas diffusion layer 21 in the form of the strip-shaped material 21S. The first electrode portion 20p is transferred to the inspection unit 58a by the conveyor. The analysis device 70a disposed in the inspection unit 58a includes the inspection box 701 and the irradiator 702. The first electrode portion 20p is carried into the inspection box 701. In this state, the analyzing step S3a is performed. In other words, the method for inspecting the electrode is executed.

As shown in FIG. 5, the irradiator 702 irradiates the first electrode portion 20p with the radiation L inside the inspection box 701. The ionomer resin 35 contained in the first protective layer 23 absorbs part of the radiation L incident on the first protective layer 23. For this reason, the amount of the radiation L that is transmitted through the first protective layer 23 and is incident on the first electrode catalyst layer 22 is smaller than the amount of the radiation L that is incident on the first protective layer 23. In this manner, in the case where the radiation L such as X-rays is emitted from the first protective layer 23 side, a smaller amount of radiation than the amount of the radiation L incident on the first protective layer 23 reaches the first electrode catalyst layer 22. Therefore, the degree of attack of the radiation L on the light element of the ionomer resin 35 contained in the first electrode catalyst layer 22 is reduced.

For the reasons described above, a situation is avoided in which the light element of the ionomer resin 35 is separated from the conductive binder. In this manner, the first protective layer 23 is provided on the first electrode catalyst layer 22, and the radiation L is made incident on the first electrode catalyst layer 22 through the first protective layer 23, whereby alteration of the ionomer resin 35 can be suppressed. Note that the light element varies depending on the type of the ionomer resin 35. In the perfluorocarbon resin having a sulfonic acid group, the light element is fluorine (F), sulfur(S), or the like. In the polymer resin having a quaternary ammonium group, the light element is nitrogen (N) or the like.

In the case where the analysis device 70a is the X-ray fluorescence analyzer 71, then as shown in FIG. 5, fluorescent X-rays Y are observed in response to the incidence of the X-rays (the radiation L) on the catalyst particles 32 of the electrode catalyst 30. The composition of the metal elements of the catalyst particles 32 can be grasped based on the fluorescent X-rays Y. That is, the operator can easily determine whether or not the first electrode catalyst layer 22 contains a predetermined amount of the electrode catalyst 30. Alternatively, the operator can easily determine whether or not the first electrode catalyst layer 22 contains impurities. Note that, in the analysis, appropriate correction is performed in consideration of the fact that the amount of the radiation L incident on the first electrode catalyst layer 22 is reduced by the first protective layer 23.

The first electrode portion 20p, which is determined to contain the predetermined amount of the electrode catalyst 30 and to contain impurities in an amount equal to or less than the allowable upper limit, is transferred to the joining unit 60 by the conveyor. In the joining unit 60, the electrolyte membrane 12 is stacked on the first protective layer 23. In this state, the hot press device 601 is operated. The press roller of the hot press device 601 presses the first electrode portion 20p and the electrolyte membrane 12 while heating them. That is, the first electrode portion 20p and the electrolyte membrane 12 are subjected to thermocompression bonding. The first protective layer 23 and the electrolyte membrane 12 are joined to each other by the thermocompression bonding. The ionomer resin 35 contained in the first protective layer 23 functions as a binder. Therefore, the first electrode portion 20p and the electrolyte membrane 12 are joined to each other with sufficient joining strength. In this manner, the surface of the first protective layer 23 on which the radiation L such as X-rays has been incident is joined to the electrolyte membrane 12.

As described above, according to the present embodiment, the electrolyte membrane 12 is joined to the first electrode portion 20p (the anode 20) that is manufactured through the electrode catalyst layer forming step S1a, the protective layer forming step S2a, and the analyzing step S3a and that is determined to contain the predetermined amount of the electrode catalyst 30. Therefore, it is possible to avoid manufacturing of a membrane electrode assembly including the anode 20 in which the electrode catalyst 30 is insufficient.

The first electrode portion 20p to which the electrolyte membrane 12 is joined is transferred to the trimming unit 62a by the conveyor. In the trimming unit 62a, the trimming step S5a is performed. That is, the first electrode portion 20p and the electrolyte membrane 12 are cut by the trimming machine 621. As a result, the joined body 40 is obtained in which the anode 20 having a predetermined surface area and the electrolyte membrane 12 having a predetermined surface area are joined to each other. A gasket (not shown) is attached to the joined body 40.

Thereafter, the electrode catalyst layer forming step S1a, the protective layer forming step S2a, the analyzing step S3a, the joining step S4, and the trimming step S5a are repeated in the same manner as described above. As a result, the joined body 40 is mass-produced on an industrial scale.

The cathode 25 shown in FIG. 1 is manufactured by the cathode manufacturing apparatus 104 shown in FIG. 3 through an electrode catalyst layer forming step S1b, a protective layer forming step S2b, and an analyzing step S3b. In the present embodiment, an aspect in which a trimming step S5b is performed after the analyzing step S3b is shown as an example.

First, as shown in FIG. 3, in order to manufacture the cathode 25, the strip-shaped material 26S is drawn out from the roll body 26R of the second gas diffusion layer 26 by the drawing rollers 522 of the drawing unit 52b.

The strip-shaped material 26S is transferred to the first coating unit 54b by the conveyor. In the first coating unit 54b, the electrode catalyst layer forming step S1b is performed. Specifically, a coating liquid A3 is supplied from the first coater 542 to the strip-shaped material 26S. The coating liquid A3 may be the same liquid as the coating liquid A1. The coating liquid A3 is dried by the first dryer 546, whereby the second electrode catalyst layer 27 is provided on one end surface of the strip-shaped material 26S.

Thereafter, the protective layer forming step S2b is performed by the second coating unit 56b. That is, a coating liquid A4 is supplied from the second coater 562 onto the second electrode catalyst layer 27. The coating liquid A4 may be the same liquid as the coating liquid A2. The coating liquid A4 is dried by the second dryer 566, whereby the second protective layer 28 is provided on the second electrode catalyst layer 27. As a result, a second electrode portion 25p is obtained.

In the second coating unit 56b, the thickness T4 of the second protective layer 28 can be made smaller than the thickness T3 of the second electrode catalyst layer 27 by the second coater 562 adjusting the supply amount of the coating liquid A4. It is also possible to obtain the second protective layer 28 having the thickness T4 of 2 μm to 20 μm by the second coater 562 adjusting the supply amount of the coating liquid A4.

Next, the analyzing step S3b is performed by the inspection unit 58b. Specifically, an irradiator 712 of the analysis device 70b (for example, the X-ray fluorescence analyzer 71) irradiates the second electrode portion 25p in an inspection box 711 with the radiation L. Note that the inspection box 701 of the analysis device 70a and the inspection box 711 of the analysis device 70b may be the same. In this case, the irradiator 702 and the irradiator 712 are provided in one inspection box.

In the same manner as described above, the second protective layer 28 reduces the degree of attack of the radiation L on the light element of the ionomer resin 35 contained in the second electrode catalyst layer 27 (see FIG. 5). In this manner, in the case where the radiation L such as X-rays is emitted from the second protective layer 28 side, a smaller amount of radiation than the amount of radiation L incident on the second protective layer 28 reaches the second electrode catalyst layer 27. Therefore, a situation is avoided in which the light element of the ionomer resin 35 is separated from the ionomer resin 35.

The second electrode portion 25p, which is determined based on the irradiation with the radiation L to contain a predetermined amount of the electrode catalyst 30 and to contain impurities in an amount equal to or less than the allowable upper limit, is transferred to the trimming unit 62b by the conveyor. In the trimming unit 62b, the trimming step S5b is performed. That is, the second electrode portion 25p is cut by the trimming machine 622, whereby the cathode 25 having a predetermined surface area is obtained. Thereafter, the electrode catalyst layer forming step S1b, the protective layer forming step S2b, the analyzing step S3b, and the trimming step S5b are repeated in the same manner as described above. As a result, the cathode 25 is mass-produced on an industrial scale.

The cathode 25 and the joined body 40 are stacked and joined to each other in a stacking step S6 shown in FIG. 4. In this joining, the second protective layer 28 is located between the electrolyte membrane 12 and the second gas diffusion layer 26. As a result, the membrane electrode assembly 10 shown in FIG. 1 is obtained. In this manner, the membrane electrode assembly 10 can be mass-produced on an industrial scale. The electrolyte membrane 12 and the second protective layer 28 are joined to each other with sufficient joining strength by the ionomer resin 35 contained in the second protective layer 28. In this manner, the surface of the second protective layer 28 on which the radiation L such as X-rays has been incident is joined to the electrolyte membrane 12.

The method for manufacturing the electrodes is not limited to the mode of feeding the strip-shaped materials 21S and 26S. For example, the anode 20 may be obtained by stacking the first electrode catalyst layer 22 and the first protective layer 23 on one end surface of the first gas diffusion layer 21 that has been cut in advance to have a predetermined surface area. Similarly, the cathode 25 may be obtained by stacking the second electrode catalyst layer 27 and the second protective layer 28 on one end surface of the second gas diffusion layer 26 that has been cut in advance to have a predetermined surface area. In this case, the trimming steps S5a and S5b are not necessary.

The membrane electrode assembly 10 is used in, for example, an electrochemical device such as a fuel cell or an electrochemical decomposition apparatus. As described above, the first electrode catalyst layer 22 and the second electrode catalyst layer 27 each contain the predetermined amount of the electrode catalyst 30. In addition, in the first electrode catalyst layer 22 and the second electrode catalyst layer 27, the amount of impurities is equal to or less than the allowable upper limit. Therefore, the electrode reaction smoothly proceeds in each of the anode 20 and the cathode 25.

As described above, the separation of the light element from the ionomer resin 35 contained in the first electrode catalyst layer 22 is suppressed, and the separation of the light element from the ionomer resin 35 contained in the second electrode catalyst layer 27 is suppressed. Therefore, each ionomer resin 35 sufficiently functions as a conductive binder. That is, the first electrode catalyst layer 22 and the second electrode catalyst layer 27 exhibit sufficient electrical conductivity and sufficient binding force.

For the reasons described above, sufficient electric power can be generated in the fuel cell. In addition, the yield of the target product is improved in the electrochemical decomposition apparatus.

The present embodiment has the following effects. Hereinafter, the anode 20 and the cathode 25 are simply referred to as an “electrode” when they do not need to be distinguished from each other. Similarly, the first electrode catalyst layer 22 and the second electrode catalyst layer 27 are simply referred to as an “electrode catalyst layer” when they do not need to be distinguished from each other, and the first protective layer 23 and the second protective layer 28 are simply referred to as a “protective layer” when they do not need to be distinguished from each other.

As shown in FIG. 4, the method for manufacturing the electrode for the membrane electrode assembly 10 includes the analyzing step S3a, S3b respectively performed after the protective layer forming step S2a, S2b of providing the protective layer (see FIG. 1) on the electrode catalyst layer. As shown in FIG. 5, in the analyzing step S3a, S3b, the analysis device 70a, 70b irradiates the protective layer with the radiation L. Part of the radiation L is blocked by the protective layer. Therefore, the amount of the radiation L incident on the electrode catalyst layer is smaller than the amount of the radiation L incident on the protective layer.

Accordingly, a situation is suppressed in which the light element of the ionomer resin 35 contained in the electrode catalyst layer is separated from the ionomer resin 35 by the radiation L. That is, alteration of the ionomer resin 35 due to the irradiation with the radiation L is suppressed. Therefore, in the case where the membrane electrode assembly 10 including this electrode is formed and a fuel cell or the like is formed using this membrane electrode assembly 10, the electrode catalyst layer exhibits sufficient electrical conductivity and binding force. That is, the ionomer resin 35 sufficiently functions as a conductive binder.

Further, the type of the ionomer resin 35 contained in the electrode catalyst layer is the same as the type of the ionomer resin 35 contained in the protective layer. Therefore, the material cost is reduced as compared to the case where the type of the ionomer resin 35 contained in the electrode catalyst layer and the type of the ionomer resin 35 contained in the protective layer are different from each other.

In the protective layer forming step S2a, S2b, the coating liquid A2, A4 containing the ionomer resin 35 is supplied (applied) to the electrode catalyst layer. Therefore, the protective layer can be easily formed on the electrode catalyst layer.

The protective layer forming step S2a, S2b includes the drying step of drying the coating liquid A2, A4. Therefore, the electrode catalyst layer can be easily analyzed.

In the protective layer forming step S2a, S2b, the protective layer is formed such that the thickness T2, T4 of the protective layer is smaller than the thickness T1, T3 of the electrode catalyst layer. This avoids the situation in which the protective layer completely blocks the radiation L in the analyzing step S3a, S3b. That is, the radiation L can be incident on the electrode catalyst layers.

The radiation L is, for example, X-rays. In this case, the elemental composition can be easily analyzed.

The method for manufacturing the membrane electrode assembly 10 includes the joining step S4 of joining the electrode manufactured as described above to the electrolyte membrane 12. As a result, it is possible to obtain the membrane electrode assembly 10 including the electrode catalyst layer determined to contain the predetermined amount of metal. Therefore, the yield of the membrane electrode assembly 10 is satisfactory.

The electrode catalyst layer forming step S1a, S1b is a step of supplying the coating liquid A1, A3 to be the electrode catalyst layer to one end surface of the strip-shaped material 21S, 26S of the gas diffusion layer. The protective layer forming step S2a, S2b is a step of supplying the coating liquid A2, A4 to be the protective layer onto the electrode catalyst layer. The analyzing step S3a, S3b is a step of making the radiation L incident, through the protective layer, on the electrode catalyst layer on the strip-shaped material 21S, 26S. Further, the trimming step S5a, S5b is a step of trimming the strip-shaped material 21S, 26S, the electrode catalyst layer, and the protective layer after the analyzing step S3a, S3b.

Through such a process, the membrane electrode assembly 10 can be mass-produced on an industrial scale.

The method for inspecting the electrode includes the analyzing step S3a, S3b of analyzing an element in the electrode catalyst layer by irradiating the electrode catalyst layer with the radiation L through the protective layer. The amount of the radiation L incident on the electrode catalyst layer is made smaller by the protective layer than the amount of the radiation L incident on the protective layer.

In the case where the radiation L is made incident on the electrode catalyst layer as described above, a situation is suppressed in which the light element among the constituent elements of the ionomer resin 35 contained in the electrode catalyst layer is separated from the ionomer resin 35. Therefore, in the membrane electrode assembly 10, the ionomer resin 35 in the electrode catalyst layer functions as a conductor and a binder.

A preferred example of the irradiation device of the radiation L that irradiates the protective layer with the radiation L is the X-ray fluorescence analyzer 71. In this case, the elemental composition of the electrode catalyst layer can be easily analyzed.

The irradiation device of the radiation L that irradiates the protective layer with the radiation L is provided in the electrode manufacturing apparatus 100 that manufactures the electrode. Therefore, manufacturing and inspection of the electrode can be consecutively performed in the mass production facility.

The following supplementary notes are further disclosed in relation to the above-described embodiment.

### Supplementary Note 1

The method for manufacturing the electrode (20, 25) of the present disclosure is a method for manufacturing an electrode for the membrane electrode assembly (10), the electrode including the gas diffusion layer (21, 26), and the electrode catalyst layer (22, 27) that is a reaction field of a gas diffused from the gas diffusion layer, the method including: the electrode catalyst layer forming step (S1a, S1b) of forming the electrode catalyst layer containing the electrode catalyst (30) and the ionomer resin (35) on one end surface of the gas diffusion layer; the protective layer forming step (S2a, S2b) of forming the protective layer (23, 28) containing the ionomer resin on the electrode catalyst layer; and the analyzing step (S3a, S3b) of irradiating the electrode catalyst layer with the radiation (L) through the protective layer and analyzing an element in the electrode catalyst layer, wherein the amount of the radiation incident on the electrode catalyst layer is made smaller by the protective layer than the amount of the radiation incident on the protective layer.

In the analyzing step, separation of the light element contained in the conductive binder from the ionomer resin can be suppressed. Therefore, after the analyzing step, the ionomer resin functions as a conductor and a binder.

### Supplementary Note 2

In the method for manufacturing the electrode according to Supplementary Note 1, the protective layer forming step may be a step of supplying the coating liquid (A2, A4) containing the ionomer resin to the electrode catalyst layer.

According to this feature, the protective layer can be easily formed.

### Supplementary Note 3

In the method for manufacturing the electrode according to Supplementary Note 2, the protective layer forming step may include the drying step of drying the coating liquid.

Since the protective layer is a dried product, it is easy to perform the analyzing step.

### Supplementary Note 4

In the method for manufacturing the electrode according to any one of Supplementary Notes 1 to 3, the protective layer may be formed in a manner so that the thickness (T2, T4) of the protective layer is smaller than the thickness (T1, T3) of the electrode catalyst layer.

According to this feature, the situation in which the protective layer completely blocks the radiation is avoided. That is, the radiation can be incident on the electrode catalyst layer.

### Supplementary Note 5

In the method for manufacturing the electrode according to any one of Supplementary Notes 1 to 4, X-rays may be emitted as the radiation.

In this case, the elemental composition of the electrode catalyst layer can be easily analyzed.

### Supplementary Note 6

The method for manufacturing the membrane electrode assembly (10) of the present disclosure is a method for manufacturing the membrane electrode assembly that includes: the electrode (20, 25) including the gas diffusion layer (21, 26), and the electrode catalyst layer (22, 27) that is a reaction field of a gas diffused from the gas diffusion layer; and the electrolyte membrane (12) including one end surface provided with the electrode, the method including: the electrode catalyst layer forming step (S1a, S1b) of forming the electrode catalyst layer containing the electrode catalyst (30) and the ionomer resin (35) on one end surface of the gas diffusion layer; the protective layer forming step (S2a, S2b) of forming the protective layer (23, 28) containing the ionomer resin on the electrode catalyst layer; the analyzing step (S3a, S3b) of irradiating the electrode catalyst layer with the radiation (L) through the protective layer and analyzing an element in the electrode catalyst layer of the electrode obtained through the electrode catalyst layer forming step and the protective layer forming step, the analyzing being performed in a state where the amount of the radiation incident on the electrode catalyst layer is made smaller by the protective layer than the amount of the radiation incident on the protective layer; and the joining step (S4) of joining the electrode that has undergone the analyzing step, to the one end surface of the electrolyte membrane.

Since the electrode that has undergone the analyzing step is joined to the electrolyte membrane, the membrane electrode assembly including the electrode catalyst layer having a predetermined amount of metal can be obtained.

### Supplementary Note 7

In the method for manufacturing the membrane electrode assembly according to Supplementary Note 6, the surface of the protective layer on which the radiation has been incident in the analyzing step may be joined to the electrolyte membrane in the joining step.

### Supplementary Note 8

In the method for manufacturing the membrane electrode assembly according to Supplementary Note 6 or 7, the protective layer may be formed in a manner so that the thickness (T2, T4) of the protective layer is smaller than the thickness (T1, T3) of the electrode catalyst layer.

As described above, the situation in which the protective layer completely blocks the radiation is avoided. That is, the radiation can be incident on the electrode catalyst layer.

### Supplementary Note 9

In the method for manufacturing the membrane electrode assembly according to any one of Supplementary Notes 6 to 8, X-rays may be emitted as the radiation.

As described above, the elemental composition of the electrode catalyst layer can be easily analyzed.

### Supplementary Note 10

In the method for manufacturing the membrane electrode assembly according to any one of Supplementary Notes 6 to 9, the electrode catalyst layer forming step may be a step of feeding the strip-shaped material (21S, 26S) of the gas diffusion layer and supplying the coating liquid (A1, A3) containing the electrode catalyst and the ionomer resin to one end surface of the strip-shaped material, the protective layer forming step may be a step of supplying the coating liquid (A2, A4) containing the ionomer resin onto the electrode catalyst layer formed on the one end surface of the strip-shaped material, the analyzing step may be a step of making the radiation incident, through the protective layer, on the electrode catalyst layer on the strip-shaped material, and the method may further include the trimming step (S5a, S5b) of trimming the strip-shaped material, the electrode catalyst layer, and the protective layer after the analyzing step.

According to this feature, it is possible to mass-produce, on an industrial scale, the membrane electrode assembly including the inspected electrode (the electrode containing a predetermined amount of a metal element in the electrode catalyst layer).

### Supplementary Note 11

The method for inspecting the electrode (20, 25) of the present disclosure is a method for inspecting the electrode for the membrane electrode assembly (10), the electrode including the gas diffusion layer (21, 26), and the electrode catalyst layer (22, 27) provided on one end surface of the gas diffusion layer and containing the electrode catalyst (30) and the ionomer resin (35), the electrode further including the protective layer (23, 28) provided on the electrode catalyst layer and containing the ionomer resin, the method including the analyzing step (S3a, S3b) of irradiating the electrode catalyst layer with the radiation (L) through the protective layer and analyzing an element in the electrode catalyst layer, wherein the amount of the radiation incident on the electrode catalyst layer is made smaller by the protective layer than the amount of the radiation incident on the protective layer.

According to this feature, separation of the light element contained in the ionomer resin from the ionomer resin can be avoided. Therefore, in the membrane electrode assembly manufactured after the analyzing step, the ionomer resin effectively functions as a conductor and a binder.

### Supplementary Note 12

In the method for inspecting the electrode according to Supplementary Note 11, the analysis device (70a, 70b) configured to irradiate the protective layer with the radiation may be the X-ray fluorescence analyzer (71).

In this case, the elemental composition of the electrode catalyst layer can be easily analyzed.

### Supplementary Note 13

In the method for inspecting the electrode according to Supplementary Note 11 or 12, the analysis device (70a, 70b) configured to irradiate the protective layer with the radiation may be provided in the electrode manufacturing apparatus (100) configured to manufacture the electrode.

According to this configuration, manufacturing and inspection of the electrode can be consecutively performed in the mass production facility.

Although the present disclosure has been described in detail, the present disclosure is not limited to the above-described individual embodiments. Various additions, replacements, modifications, partial deletions, and the like can be made to these embodiments without departing from the essence and gist of the present disclosure, or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A method for manufacturing an electrode for a membrane electrode assembly, the electrode including a gas diffusion layer, and an electrode catalyst layer that is a reaction field of a gas diffused from the gas diffusion layer, the method comprising:
forming the electrode catalyst layer containing an electrode catalyst and an ionomer resin on one end surface of the gas diffusion layer;
forming a protective layer containing the ionomer resin on the electrode catalyst layer; and
irradiating the electrode catalyst layer with radiation through the protective layer and analyzing an element in the electrode catalyst layer,
wherein an amount of the radiation incident on the electrode catalyst layer is made smaller by the protective layer than an amount of the radiation incident on the protective layer.

2. The method for manufacturing the electrode according to claim 1, wherein
in the forming of the protective layer, a coating liquid containing the ionomer resin is supplied to the electrode catalyst layer.

3. The method for manufacturing the electrode according to claim 2, wherein
the forming of the protective layer includes drying the coating liquid.

4. The method for manufacturing the electrode according to claim 1, wherein
the protective layer is formed in a manner so that a thickness of the protective layer is smaller than a thickness of the electrode catalyst layer.

5. The method for manufacturing the electrode according to claim 1, wherein
X-rays are emitted as the radiation.

6. A method for manufacturing a membrane electrode assembly that includes: an electrode including a gas diffusion layer, and an electrode catalyst layer that is a reaction field of a gas diffused from the gas diffusion layer; and an electrolyte membrane including one end surface provided with the electrode, the method comprising:
forming the electrode catalyst layer containing an electrode catalyst and an ionomer resin on one end surface of the gas diffusion layer;
forming a protective layer containing the ionomer resin on the electrode catalyst layer;
irradiating the electrode catalyst layer with radiation through the protective layer and analyzing an element in the electrode catalyst layer of the electrode obtained through the forming of the electrode catalyst layer and the forming of the protective layer, the analyzing being performed in a state where an amount of the radiation incident on the electrode catalyst layer is made smaller by the protective layer than an amount of the radiation incident on the protective layer; and
joining the electrode that has undergone the analyzing, to the one end surface of the electrolyte membrane.

7. The method for manufacturing the membrane electrode assembly according to claim 6, wherein
in the joining of the electrode to the one end surface of the electrolyte membrane, a surface of the protective layer on which the radiation has been incident in the analyzing is joined to the electrolyte membrane.

8. The method for manufacturing the membrane electrode assembly according to claim 6, wherein
the protective layer is formed in a manner so that a thickness of the protective layer is smaller than a thickness of the electrode catalyst layer.

9. The method for manufacturing the membrane electrode assembly according to claim 6, wherein
X-rays are emitted as the radiation.

10. The method for manufacturing the membrane electrode assembly according to claim 6, wherein
in the forming of the electrode catalyst layer, a strip-shaped material of the gas diffusion layer is fed and a coating liquid containing the electrode catalyst and the ionomer resin is supplied to one end surface of the strip-shaped material,
in the forming of the protective layer, a coating liquid containing the ionomer resin is supplied onto the electrode catalyst layer formed on the one end surface of the strip-shaped material, and
in the analyzing, the radiation is made incident, through the protective layer, on the electrode catalyst layer on the strip-shaped material,
the method further comprising, after the analyzing, trimming the strip-shaped material, the electrode catalyst layer, and the protective layer.

11. A method for inspecting an electrode for a membrane electrode assembly, the electrode including a gas diffusion layer, and an electrode catalyst layer provided on one end surface of the gas diffusion layer and containing an electrode catalyst and an ionomer resin,
the electrode further including a protective layer provided on the electrode catalyst layer and containing the ionomer resin,
the method comprising irradiating the electrode catalyst layer with radiation through the protective layer and analyzing an element in the electrode catalyst layer,
wherein an amount of the radiation incident on the electrode catalyst layer is made smaller by the protective layer than an amount of the radiation incident on the protective layer.

12. The method for inspecting the electrode according to claim 11, wherein
an analysis device configured to irradiate the protective layer with the radiation is an X-ray fluorescence analyzer.

13. The method for inspecting the electrode according to claim 11, wherein
an analysis device configured to irradiate the protective layer with the radiation is provided in an electrode manufacturing apparatus configured to manufacture the electrode.
